(19) United States
(12) Patent Application Publication
(10) Pub. No.: US 2011/0203465 A1
(43) Pub. Date: Aug. 25, 2011

(54) Trash compactor

(76) Inventor: Garth Bullock, Pismo Beach, CA (US)

(21) Appl. No.: 12/660,132

(22) Filed: Feb. 22, 2010

(51) Int. Cl. B30B 12/00

(52) U.S. Cl. 100/353

(57) ABSTRACT

A handheld manual trash compactor for use with residential curbside refuse carts and containers that is adjustable in height including a plunger and actuating lever which hooks into existing handles of the containers using leverage to compact waste further into the container enabling more space and proper lid closure.

### DESCRIPTION

This invention relates to a handheld manual trash compactor specifically for use in curbside residential refuse carts and containers of various sizes to condense the overflow of trash.

### BACKGROUND OF THE INVENTION

There has always been a trash compacting problem in regards to recyclables, trash, and green waste into curbside refuse carts and containers. Many times it is not possible to fully compact the refuse, in order to securely close the lid of the designated curbside containers. The inability to properly secure the lid will result in the local sanitation and refuse company, either charging additional pickup fees and/or a rejection notification to dispose of the waste.

The typical residential trash containers for a single residence consists of one recycle, one green waste, and one refuse container. If overflow occurs the excess waste must be put aside until the following sanitation pick up. This overabundance of waste can result in attracting undesirable bugs, insects, various animals, and potential health hazards.

### SUMMARY OF THE INVENTION

The main advantage of the invention is being able to compact refuse in various sizes of curbside containers. This invention easily adjusts to compact different levels of waste in the multiple refuse carts and containers. The trash compactor uses the existing handles of the refuse carts by hooking on and using leverage to compact the waste.

Excess refuse, which would normally be left over for the next sanitation pickup, would be compacted easily in the refuse containers with the present invention. This invention will provide ample compacting of weekly waste. The issue of lids not being closed completely and being charged more for extra waste pick up will be resolved.

The handheld trash compactor is constructed to be hooked on the handle while the lid is open. The actuating lever is then inserted along the ratchet curves above the waste level. Manual downward pressure on the actuating lever will then compact the waste.

### DESCRIPTION OF THE DRAWINGS

FIG. 1 is a perspective view of the compressor apparatus including the plunger and compression notches;

FIG. 2 is a perspective view of the actuating lever with hook and ratchet curves to connect with the compressor apparatus;

FIG. 3 is a perspective view of the trash compacting plunger apparatus of the present invention, including the actuating lever in its normal working position.

### DESCRIPTION OF THE INVENTION

Referring to FIG. 1, the compressor apparatus plunger base for compacting waste is identified by reference character 2. In accordance with the present invention overflow of waste in curbside residential refuse carts and containers is significantly reduced by the use of the compacting plunger. The plunger base is supported by the riser as identified by reference character 1. The plunger is so supported that it may be manually advanced downward in order to compact and lower the trash level repeatedly as necessary until the proper adequate space is reached in order to properly close the refuse container lid.

Compression notches cut into the riser of the compressor apparatus allow for four different levels of height adjustment and compression strength which are identified by reference character 3.

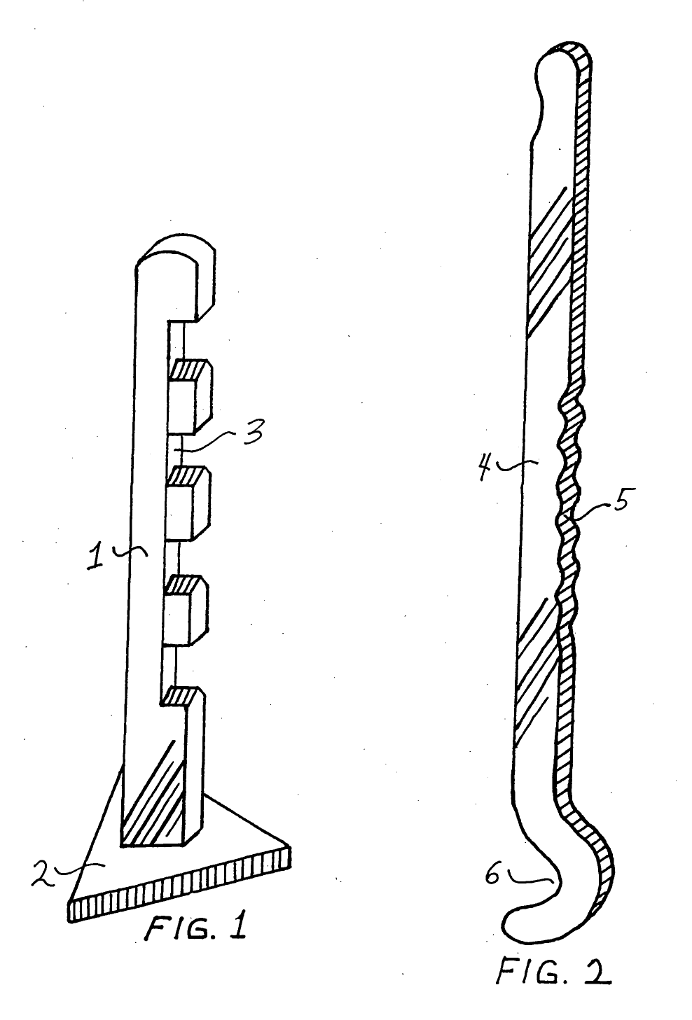

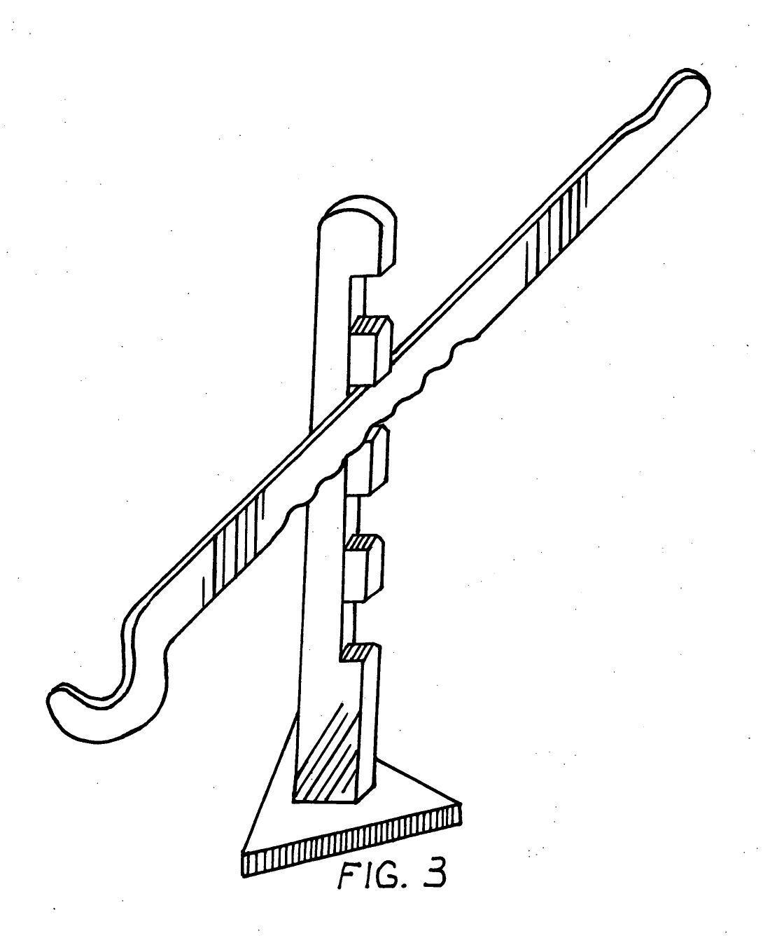

Referring to FIG. 2, the actuating lever that inserts into the compressor apparatus is identified by reference character 4. The ratchet curves which align against the compression notches, of the plunger riser, are identified by the reference character 5. The hook that is placed on the refuse cart or container handle, which uses leverage by manual handheld pressure, is identified by reference character 6.

Referring to FIG. 3, presenting the complete view of the present invention where the actuating lever is aligned with the compression notches and ready to compact waste in this ready action working position. Normal residential refuse carts and containers of various sizes can all be serviced by the present invention. The manual handheld trash compactor allows for ease of use and for utilization of full capacity of various refuse containers. Repeated compacting will allow for more space within the carts. Assembly of the compressor apparatus and actuating lever easily adjust to compact various heights of waste buildup inside the carts and containers. This invention disassembles quickly and conveniently for storage and future use.

I claim:

1. In combination with the existing handles of the curbside refuse carts and containers the handheld manual apparatus hooks onto the handle, while the lid is open; thereby using manual downward pressure on the actuating lever which will compact the waste by leverage, against the plunger, in the various sized curbside refuse carts and containers.
